(19) United States
(12) Patent Application Publication
(10) Pub. No.: US 2015/0131446 A1
(43) Pub. Date: May 14, 2015

(54) ENABLING VIRTUAL QUEUES WITH QOS AND PFC SUPPORT AND STRICT PRIORITY SCHEDULING

(71) Applicant: BROADCOM CORPORATION, Irvine, CA (US)

(72) Inventors: Bruce Hui KWAN, Sunnyvale, CA (US); Chiara Piglione, San Jose, CA (US); Puneet Agarwal, Cupertino, CA (US); Vahid Tabatabaee, Potomac, MD (US)

(73) Assignee: BROADCOM CORPORATION, Irvine, CA (US)

(21) Appl. No.: 14/538,730

(22) Filed: Nov. 11, 2014

Related U.S. Application Data
(60) Provisional application No. 61/902,620, filed on Nov. 11, 2013.

(51) Int. Cl. H04L 12/863; H04L 12/26; H04L 12/865; H04L 12/833

(52) U.S. Cl. CPC H04L 47/6215; H04L 47/31; H04L 43/0894; H04L 47/6275
USPC 370/235

(57) ABSTRACT

To reduce latency in a network device that buffer packets in different queues based on class of service, packets received from a network are stored in physical queues according to a class of service associated with the packets and a class of service associated with each of the physical queues. The physical queues are scheduled based quality of service requirements of their associated class of service. The physical queues are shadowed by virtual queues, and whether congestion exists in at least one of the virtual queues is determined. Packets departing from at least one of the physical queues are marked when congestion exists in at least one of the virtual queues. The service rate of the virtual queues is set to be less than or equal to a port link rate of the network device.

### CROSS-REFERENCE TO RELATED APPLICATIONS

This application is based upon and claims the benefit of priority to provisional U.S. Application No. 61/902,620 entitled “Enabling Virtual Queues with QoS and PFC Support and Strict Priority Scheduling” and filed Nov. 11, 2013. The entire contents of this provisional application are incorporated herein by reference.

### FIELD

Exemplary embodiments of the present disclosure relate to reducing network latency in network components. More specifically, the exemplary embodiments relate to methods, devices and computer-readable media for reducing latency in network components having one or more physical queues using one or more virtual queues.

### BACKGROUND

In ideal networks, data backups would not occur in network switching, and electronic memory would not be needed in network components in order to implement and manage data queues. In reality, network switches support different applications that have different performance requirements and make different demands of the network. This can lead to different priorities and classifications of data communicated over the network, and network switching backups can result.

### SUMMARY

An apparatus, computer-readable medium and associated methodology for reducing latency in network components having a plurality of physical queues by using a plurality of virtual queues, as set forth more completely in the claims

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a block diagram of an egress port of a network switch according to exemplary aspects of the present disclosure;

FIG. 2 is a block diagram of an egress port with a virtual queue according to exemplary aspects of the present disclosure;

FIG. 3 is an algorithmic flowchart of virtual queueing according to exemplary aspects of the present disclosure;

FIG. 4 is a block diagram of a network switch egress port including multiple physical queues corresponding to different classes of services and multiple virtual queues which correspond to exemplary aspects of the present disclosure;

FIG. 5 is an algorithmic flow chart of virtual queueing in the egress port of FIG. 4 according to exemplary aspects of the present disclosure;

FIG. 6 is a table relating service rates of physical queues to service rates of virtual queues according to exemplary aspects of the present disclosure;

FIG. 7 is an algorithmic flow chart of setting service rates for virtual queueing according to exemplary aspects of the present disclosure;

FIG. 8 is a table of virtual queue monitoring of physical queues under a strict priority scheduling scheme according to exemplary aspects of the present disclosure;

FIG. 9 is an algorithmic flowchart of virtual queueing under a strict priority scheme according to exemplary aspects of the present disclosure; and

FIG. 10 is a hardware schematic diagram according to exemplary aspects of the present disclosure.

### DETAILED DESCRIPTION

In an exemplary aspect, a method for reducing latency in a network device includes storing packets received from a network in a plurality of physical queues in circuitry of the network device. Each packet is stored according to an associated class of service (COS) and a COS associated with each of the physical queues. Each physical queue is also scheduled according to its corresponding COS and, more specifically, in accordance with a quality of service (QoS) set for the COS. The method also includes shadowing the plurality of physical queues with a plurality of virtual queues that are implemented in the circuitry of the network device, and determining, with the circuitry of the network device, whether congestion exists in at least one of the plurality of virtual queues. Packets departing from at least one of the plurality of physical queues are marked by the circuitry of the network device, when congestion is determined to exist in the at least one of the virtual queues. In the method, a service rate of the virtual queues is less than or equal to a port link rate of the network device.

In another exemplary aspect, a device for reducing latency in a network apparatus includes circuitry configured to store packets received from a network in a plurality of physical queues according to a class of service (COS) associated with each packet and a COS associated with each physical queue. The physical queues are scheduled according to their associated COS and, more specifically, in accordance with a QoS set for that COS. The circuitry is also configured to shadow the plurality of physical queues with a plurality of virtual queues, and to determine whether congestion exists in at least one of the plurality of virtual queues. The circuitry marks packets departing from at least one of the plurality of physical queues when congestion is determined to exist in the at least one of the plurality of virtual queues, and a service rate of the virtual queues is less than or equal to a port link rate of the network device.

In a further exemplary aspect, a non-transitory computer-readable medium is encoded with computer-readable instructions that, when executed by a processor, cause the processor to perform a method for reducing latency in a network component. The method includes storing packets received from a network in a plurality of physical queues, where each packet is stored according to a class of service (COS) associated with the packet and a COS associated with each of the physical queues. The physical queues are scheduled according to their associated COS and, more specifically, according to the QoS set for that COS. The method also includes shadowing the plurality of physical queues with a plurality of virtual queues, and determining whether congestion exists in at least one of the virtual queues. The method further includes marking packets departing from at least one of the plurality of physical queues, when congestion is determined to exist in the at least one of the virtual queues. The service rate of the virtual queues is less than or equal to the port link rate of a network device in which the processor is included.

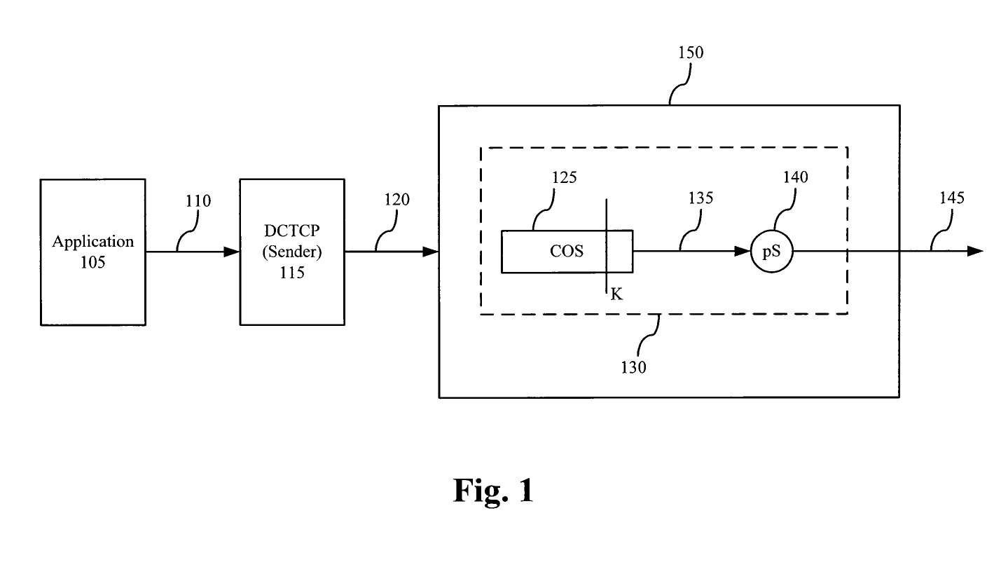

Referring now to the drawings, wherein like reference numerals designate identical or corresponding parts throughout the several views, FIG. 1 is a block diagram of a network switch egress port according to exemplary aspects of the present disclosure. In FIG. 1, an application 105 places a demand 110 on a sender device 115 that employs Data Center Transmission Control Protocol (DCTCP). As can be appreciated the demand 110 can be a demand to transmit data packets at a specific rate, such as 10 GB/s for example. The DCTCP sender 115 sends packets to the egress port 150 of the network switch with an arrival rate 120 that, at least initially, corresponds to the demand 110 of the application 105.

The egress port 150 of the network switch includes a class of service (COS) processing circuit 130 that has a physical queue 125 and a physical link scheduler 140. The packets received at the arrival rate 120 are stored in the physical queue 125 and are serviced at a service rate 135 set by the physical link scheduler 140. The physical link rate 145 is an attribute of the egress port 150 itself, and the physical service rate 135 is less than or, at most, equal to the physical link rate 145. When the egress port 150 includes multiple physical queues, the sum of their respective physical service rates will be less than or equal to the physical port link rate 145.

Returning to the example of FIG. 1, the physical queue 125 fills with packets at the arrival rate 120 and empties at the service rate 135. If there is congestion, the physical queue 125 will fill at a rate that is the difference between the arrival rate 120 and the service rate 135. This congestion occurs when there is a build-up of packets in the physical queue 125, and increases latency. In the case that the packet arrival rate 125 equals the packet service rate 135 of the physical queue 125, the physical queue 125 remains at a steady state with little or no occupancy. That is, since the physical queue 125 services each packet as it arrives from the DCTCP sender 115, the physical queue 125 remains empty or buffers only a small number of packets, i.e., the occupancy of the physical queue 125 is zero or some small number.

If the arrival rate 120 of the packets is greater that the service rate 135 provided by the COS processing circuit 130, the occupancy of the physical queue 125 rises as the physical queue 125 stores more and more packets in an effort to compensate for the difference between the arrival rate 120 and the service rate 135. This causes congestion in the COS processing circuit 130 since it is not able to transmit packets at the same rate as it receives them, and may result in degradation in the quality of service (QoS) that is needed for the particular COS handled by the COS processing circuit 130.

To mitigate the effects of a disparity between the arrival rate 120 and the service rate 135, a threshold K, which may be fixed or user-settable, can be established to identify congestion in the physical queue 125 before the physical queue 125 is fully occupied by packets. When the occupancy of the physical buffer 125 reaches the threshold K, the COS processing circuit 130 begins marking packets to communicate that the physical queue 125 is congested to other network devices, such as the DCTCP sender 115. The other network devices receive information regarding the congestion in the physical queue 125 based on the number of marked packets, and reduce their transmission rate accordingly. This effectively lowers the arrival rate 120, allowing the physical queue 125 to drain below the threshold K. Once this occurs, the COS processing circuit 130 stops marking packets and the arrival rate 120 is allowed to increase.

As can be appreciated, congestion in the physical queue 125 may be determined by methods other than comparing occupancy to a threshold. The rate at which the physical queue 125 fills with packets may also be used to identify congestion. For example, congestion may be identified if the physical queue 125 fills at a rate that exceeds a predetermined value regardless of whether the occupancy of the physical queue 125 exceeds the threshold K. Of course, the rate at which the physical queue 125 fills with packets may be used in conjunction with the occupancy thresholding described above in order to identify congestion. Other methods of identifying congestion are also possible without departing from the scope of the present disclosure.

The packet marking can be performed by marking each packet with a single “congestion” bit, or by marking each packet with a multi-bit word identifying the level of congestion present in the physical queue 125. In the case that each packet is marked by a single bit, the network devices determine the amount of congestion by the number of packets marked. For example, a relatively low level of congestion may be communicated to the network device by marking one packet out of a hundred, and a relatively high level of congestion may be indicated by marking ninety out of a hundred packets. In this way, the network devices are able to determine both the presence and level of congestion and throttle back their respective transmission rates accordingly.

Alternatively, the egress port 150 may send an explicit congestion message to the network devices instead of marking packets. Thus, the specific manner in which network devices are notified of the congestion in the egress port 150 is not limiting upon the present disclosure.

For the sake of brevity, FIG. 1 illustrates only one egress port 150 of the network switch, and only one DCTCP sender 115 and one application 105 communicating with the egress port 150. However, the network switch may have multiple egress ports such as egress port 150, or of a different structure, as well as other circuits and components as one of ordinary skill will recognize. Therefore FIG. 1 is merely exemplary and therefore not limiting on the present disclosure.

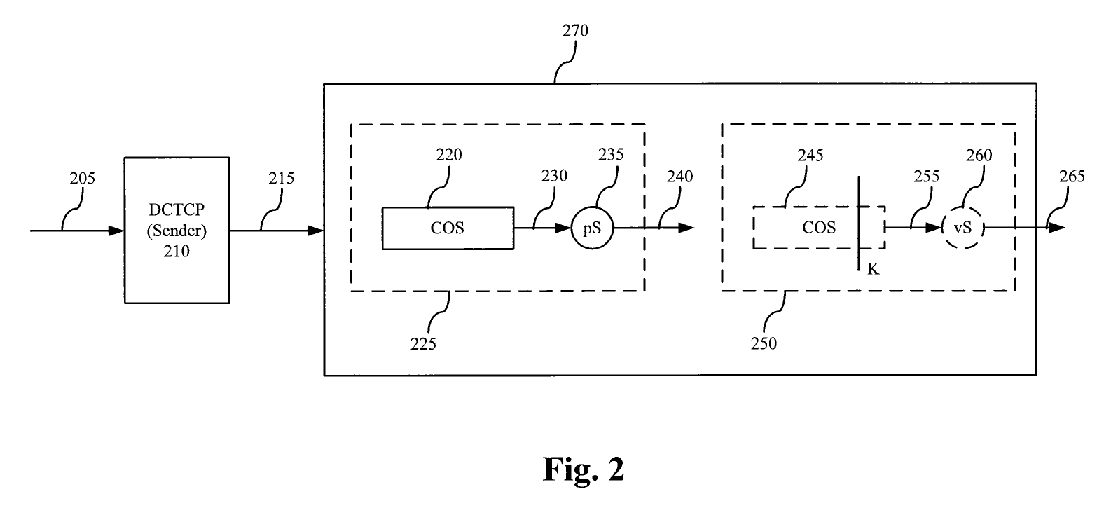

FIG. 2 is another network switch egress port according to exemplary aspects of the present disclosure. In FIG. 2, the DCTCP sender provides packets to the egress port 270 at an arrival rate 215 dictated by the demand 205 of, for example, an application (not shown). The egress port 270 includes both a physical COS processing circuit 225 and a virtual COS processing circuit 250 which shadows, or monitors, the physical COS processing circuit. The physical COS processing circuit 225 includes a physical queue 220 and a physical link scheduler 235. The virtual COS processing circuit 250 includes a virtual queue 245 and a virtual link scheduler 260. In addition, the threshold K is applied to the virtual queue 245 in order to determine whether congestion exists in the virtual queue 245 or not. The service rate of the virtual queue 255 is set to be equal to or less than the service rate 230 of the physical queue 220. For example, the service rate 255 of the virtual queue 245 may be set to 95% of the service rate 230 of the physical queue 220.

In operation, packets are received by the physical queue 220 at the arrival rate 215. While the packets are physically stored in the physical queue 220, they are also virtually stored in the virtual queue 245. For example, the virtual queue 245 may be a counter that is incremented each time a packet is serviced, i.e., departs from, the physical queue 220, and is decremented based on the service rate 255 of the virtual queue 245. When the service rate 255 of the virtual queue 245 is less than the service rate 230 of the physical queue 220, the virtual queue 245 fills faster than the physical queue 220. If the occupancy of the virtual queue 245 reaches the threshold K, packets departing from the physical queue 220 are marked as described above in order to signal congestion to other network devices. This means that while the virtual queue 245 may become congested, the physical queue 220 will actually store only a number of packets or even no packets at all because the physical queue 220 drains faster than the virtual queue 245.

The threshold K can be set to any value, as will be appreciated by one of ordinary skill in the art. As noted above, the rate at which the virtual queue 245 fills may also be used instead of, or in addition to, the threshold K. Egress port 270 may also send congestion messages to the other network devices, rather than mark packets, as can be appreciated.

Also, the service rate 255 of the virtual queue 245 may be set to any value based on network conditions and desired performance. However, setting the service rate 255 of the virtual queue 245 much lower than the service rate 230 of the physical queue will result in a high number of marked packets and can dramatically slow throughput via the egress port 270. In practice, setting the service rate 255 of the virtual queue 245 slightly below that of the physical queue 220 will have the desired effect of reducing congestion and the resulting latency without dramatically affecting overall throughput. Of course, the service rate 255 of the virtual queue 245 may be set equal to the service rate 230 of the physical queue 220, but this will cause the virtual queue 245 to fill at the same rate as the physical queue 220 and diminish the virtual queue's 245 ability to avoid packet build-up in the physical queue 220, and hence diminish its ability to reduce latency.

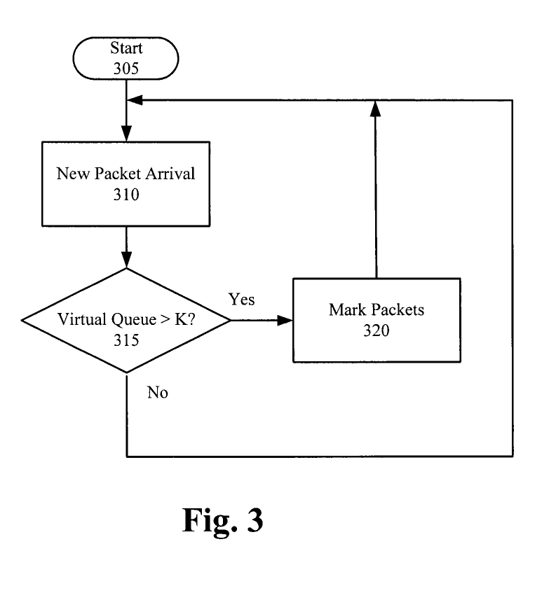

Next, FIG. 3 is an algorithmic flow chart of the process for reducing latency in a network device according to exemplary embodiments of the present disclosure. The process of FIG. 3 begins at step 305 and moves to step 310 in which a new packet arrives at the virtual queue, for example virtual queue 245 of FIG. 2. At step 315 the occupancy of the virtual queue 245 is checked against the threshold K. If at step 315 it is determined that the occupancy of the virtual queue 245 exceeds the threshold K, the newly arrived packet is marked at step 320. Then the process reverts to step 310 to await the arrival of another packet. If at step 315, it is determined that the occupancy of the virtual queue 245 does not exceed the threshold K, the process reverts back to step 310 to await the arrival of another packet without marking the packet just received.

As can be appreciated, other processes for determining and mitigating congestion are also possible. For example, the occupancy of the virtual queue 245 can be determined periodically, and compared to the threshold K. Thus the above descriptions with regard to FIG. 3 are exemplary and in no way limit the present disclosure

Although the above descriptions relative to FIGS. 1-3 describe determining congestion using a threshold against which the number of queued packets is checked. Other methods of determining congestion are also possible. For example, congestion may be determined when the number of packets in a queue fails to reach zero within a predetermined time period. Thus, the method used to determine whether congestion exists in either a physical queue or a virtual queue is also not limiting upon the present disclosure.

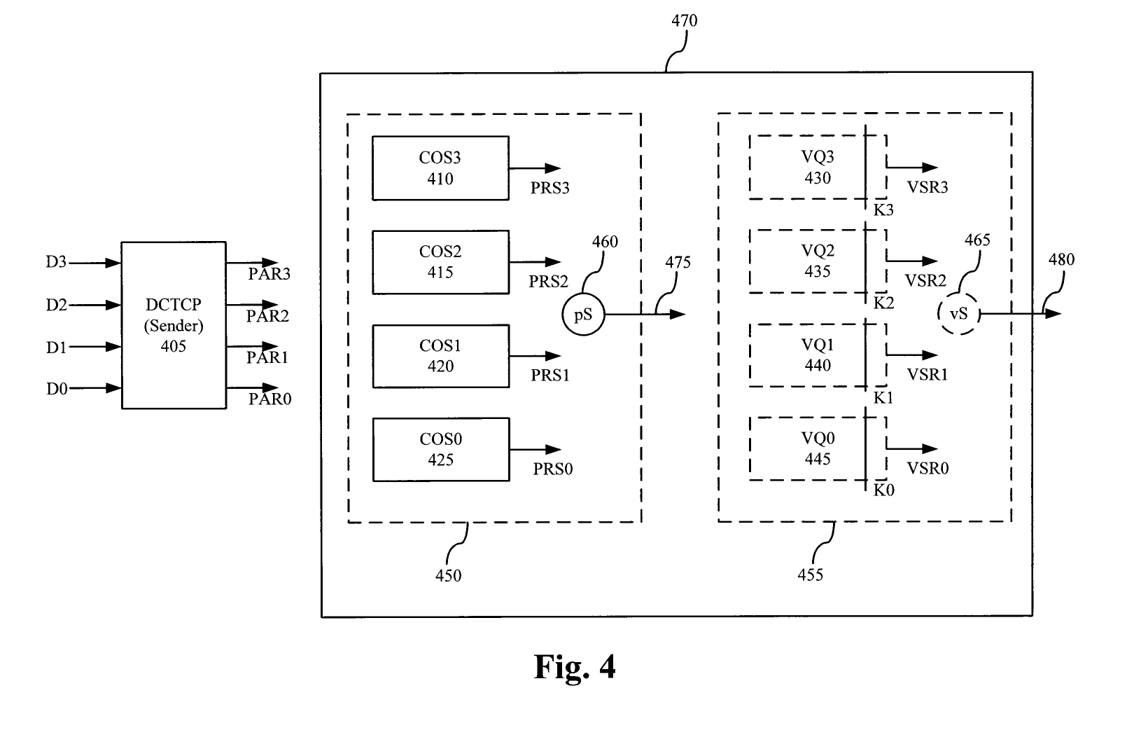

Next, an egress port 470 with multiple service queues is described with reference to FIG. 4. In FIG. 4, multiple demands D0-D3 are placed upon the DCTCP sender 405 resulting in different packet streams arriving at the egress port 470 with arrival rates PAR0-PAR3. As can be appreciated, the arrival rates PAR0-PAR3 may be the same or may be different depending on the corresponding demand D0-D3. As can also be appreciated, the demands D0-D3 are placed based on differing classes of services required. Thus, the packets arriving at the egress port 470 correspond to different classes of services.

The egress port 470 includes a physical COS processing circuit 450 and a virtual COS processing circuit 455. The physical COS processing circuit, in turn, includes four physical queues 410, 415, 420, 425, each corresponding to a different COS. Packets from the physical queues 410, 415, 420, 425 are scheduled by the physical link scheduler 460 according to the physical service rates PRS0-PRS3 of the physical queues 425, 420, 415, 410, respectively in order to output a stream of packets at the physical link rate 475, which is a function of the egress port 470.

The virtual COS processing circuit 455 includes four virtual queues 430, 435, 440, 445 and a virtual link scheduler 465 that sets the virtual link rate 480 and each of the virtual service rates VSR0-VSR3. The virtual queues 430, 435, 440, 445 shadow, or monitor, the physical queues 410, 415, 420, 425. Therefore, the virtual queues 430, 435, 440, 445 may be counters. Each of the virtual queues 430, 435, 440, 445 has a corresponding threshold K3-K0 in order to determine congestion. Thus, the occupancy of virtual queue 430 is compared to threshold K3, the occupancy of virtual queue 435 is compared to threshold K2, the occupancy of virtual queue 440 is compared to threshold K1, and the occupancy of virtual queue 445 is compared to threshold K0. As can be appreciated, the thresholds K0-K3 may be set to the same value or may be set to different values according to the performance desired for a given COS. Instead of, or in addition to, thresholding the occupancy of the virtual queues 430, 435, 440, 445, the rate at which these queues fill, i.e., their count rates may be used to identify congestion, as described above.

Because each physical queue 410, 415, 420, 425 of FIG. 4 corresponds to a different COS, the physical queues 410, 415, 420, 425 are scheduled based on the quality of service (QoS) requirements their respective COS. This separation of physical queues, and corresponding virtual queues, allows for the implementation of priority-based flow control (PFC), which provides link-level flow control that is independently controlled for each COS.

The scheduling of the physical queues 410, 415, 420, 425 by the physical link scheduler 460 may result in the allocation of more bandwidth to one physical queue, for example the physical queue 410, than another, such as the physical queue 425. The virtual queues 430, 435, 440, 445 shadow the physical queues 410, 415, 420, 425 in a one-to-one correspondence. As such, the virtual link scheduler provides the most bandwidth to the virtual queue 430 since physical queue 410, which is monitored by virtual queue 430 has the most bandwidth among the physical queues. As noted above, however, the service rates VSR0-VSR3 of the virtual queues 445, 440, 435, 430 are set to be equal to, or preferably slightly less than, the physical service rates PSR0-PSR3 of the physical queues 425, 420, 415, 410.

In operation packets arriving at the arrival rates PAR0-PAR3 are placed in the different physical queues 410, 415, 420, 425 according to the COS associated with each packet. The virtual queues 430, 435, 440, 445 count, or virtually store, the packets that exit the corresponding physical queues 410, 415, 420, 425. Upon arrival of packets at the virtual queues 430, 435, 440, 445, the occupancy of the virtual queues 430, 435, 440, 445 are compared to their respective thresholds K3-K0. If any of the virtual queues 430, 435, 440, 445 exceeds its respective threshold K3-K0, the newly arrived packet(s) is/are marked to signal congestion to other network devices. Alternatively, the egress port 470 may send out express congestion messages to the other network devices.

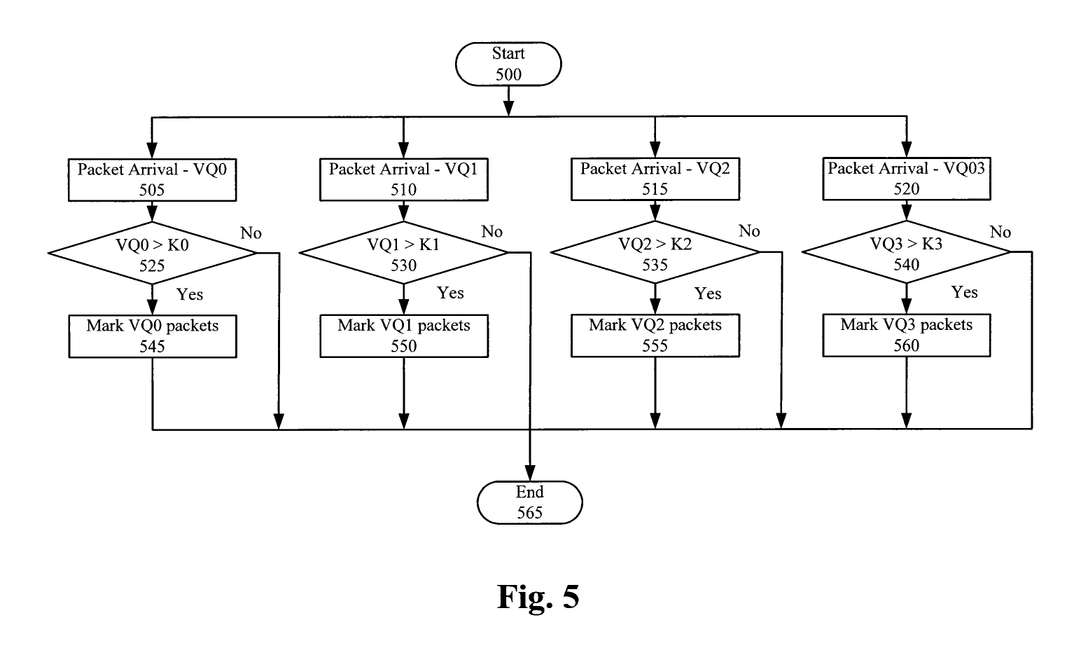

Next, a method for reducing latency according to exemplary aspects of the disclosure is described with reference to the algorithmic flowchart of FIG. 5. The following descriptions relating to FIG. 5 are provided in a sequential manner solely for the purpose of aiding the reader in understanding the concepts presented. However, it should be understood that the processing of each virtual queue described below is actually performed in parallel. When the process is described as ending for a given virtual queue, it should be understood that the process ends solely for that virtual queue, and may still be ongoing with respect to one or more of the other queues.

The process of FIG. 5 begins at step 500 and moves to one of steps 505, 510, 515 and 520 depending upon which virtual queue VQ0-VQ3 has a packet arrival. With respect to VQ0, packet arrival occurs at step 505. The occupancy of VQ0 is then compared to the threshold K0 at step 525. If the occupancy of VQ0 exceeds the threshold K0, the newly arrived packet is marked at step 545 and then the process ends at step 565. If, on the other hand, the occupancy of VQ0 is less than the threshold K0, the process ends at step 565 without marking the newly arrived packet.

When a packet arrives at virtual queue VQ1 at step 510, the occupancy of VQ1 is checked against the threshold K1 at step 530, and the newly arrived packet is marked at step 550 if the threshold K1 is determined to be exceeded at step 530. Then the process ends at step 565. If at step 530, it is determined that the occupancy of VQ1 is less than the threshold K1, the process ends at step 565 without marking the new packet.

When a packet arrives at virtual queue VQ2 at step 515, the process moves to step 535 to compare the occupancy of VQ2 against the threshold K2. If the threshold K2 is exceeded, the newly arrived packet is marked at step 555, and the process ends at step 565. If, on the other hand, the occupancy of VQ2 does not exceed the threshold K2, the process directly ends at step 565 without marking the new packet.

In the event that a packet arrives at virtual queue VQ3 in step 520, the process moves to step 540 in order to determine whether the occupancy of VQ3 exceeds the threshold K3. If it does, the process moves to step 560 where the newly arrived packet is marked, and then ends at step 565. If at step 540 it is determined that the occupancy of VQ3 does not exceed the threshold K3, the process ends at step 565 without marking the new packet.

The process of FIG. 3 is an event-driven process in which only the occupancy of virtual queue VQ0-VQ3 that receives a new packet is checked against its corresponding threshold K0-K3. Thus, each virtual queue VQ0-VQ3 can be checked independently of the others. As noted above, this also means that the virtual queues VQ0-VQ3 may be checked simultaneously and in any order since the checking of one virtual queue is not dependent on the completion of a check on another virtual queue. Of course, the virtual queues VQ0-VQ3 may also be checked sequentially by polling their occupancies at predetermined intervals regardless of the arrival of new packets.

Moreover, the above descriptions of FIGS. 4-5 are based on an egress port having four physical queues, each corresponding to a different COS, and four virtual queues. However, an egress port with more physical/virtual queues or fewer physical/virtual queues may be used without departing from the scope of the present disclosure. Likewise, the egress port may handle more than four COS types or fewer than four types of COS. Therefore, the above descriptions are merely exemplary and do not in any way limit the present disclosure.

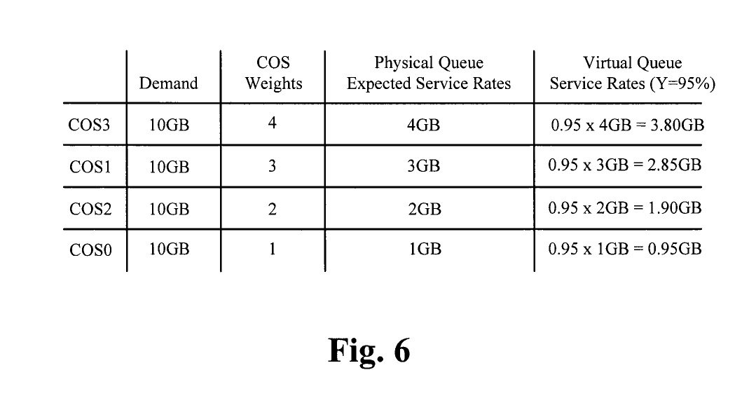

Next, a description of scheduling of physical queues according to exemplary aspects of the present disclosure is provided with reference to the table of FIG. 6. In FIG. 6, four physical queues labeled COS0-COS3 are scheduled based on the quality of service (QoS) requirements of the COS handled by each physical queue. For example the physical queue COS3 may be scheduled to have the largest bandwidth because of the QoS requirements of its COS, and the physical queue COS0 may be scheduled to have the lowest. However, this scheduling may be reversed or set differently, as one of ordinary skill will appreciate.

The demand for each COS handled by the physical queues COS0-COS3 is the same, 10 GB. To schedule COS3 to have the highest bandwidth, it is assigned the largest weight, which results in the largest bandwidth allocation of 4 GB. COS2-COS0 are respectively assigned weights 3, 2, 1 and have bandwidth allocations of 3 GB, 2 GB and 1 GB. In other words, at full rate, the expected service rates for COS3-COS4 is 4 GB, 3 GB, 2 GB and 1 GB, respectively. Of course, the demands, weights and bandwidth allocations of FIG. 6 are given exemplary values to aid in the understanding of the inventive concepts described herein. One of ordinary skill will recognize that these parameters may take on any value, and as such the specific values attributed to these parameters in FIG. 6 do not, in any way, limit the present disclosure.

Returning to FIG. 6, the service rates for the virtual queues that shadow COS3-COS0, for example VQ3-VQ0 of FIG. 4, are a fraction Y of the service rate for the physical queues COS3-COS0. In this example, the fraction Y is 95% such that VQ3 has a service rate of 3.80 GB, VQ2 has a service rate of 2.85 GB, VQ1 has a service rate of 1.90 GB, and VQ0 has a service rate of 0.95 GB. Because the service rates of the virtual queues are lower than the service rates of the physical queues, the virtual queues will experience congestion before the physical queues. As a result congestion notifications, in the form of marked packets, will be sent throughout the network based on the congestion experienced by the virtual queue, and the demand lowered as a result. Thus, the physical queues may not become congested since the conditions leading to congestion are dealt with through the virtual queues.

While the system of FIG. 6 effectively deals with congestion, it may result in drastically lower throughput. This is because the service rates of the virtual queues are set as a fraction of the service rates of the physical queues, but the service rates of the physical queues are not know a priori. Instead, the service rate of each physical queue is periodically estimated based on the number of bytes departing the physical queue in a predetermined period of time. In one exemplary method, the service rate of the physical queue may be estimated by dividing the number of bytes exiting the physical queue by the time period used to measure the number of bytes. Other methods are also possible, as will be appreciated.

Setting the service rates of the virtual queues at 95% of the service rates of the physical queues means that the virtual queues will experience congestions before the physical queues, and take steps to mitigate the congestion by notifying the other network devices. If the other network devices lower their demand, the arrival rates at the egress port will be lowered, and the service rates of the physical queues will also be effectively lowered. As a result, the service rates of the virtual queues, which are 95% of the service rates of the physical queues, will be lowered. This means that in the next iteration, the virtual queues will experience congestion even sooner, and send out marked packets as a result, further lowering the arrival rates and the physical service rates. This cycle can continue until the throughput for each COS effectively becomes zero.

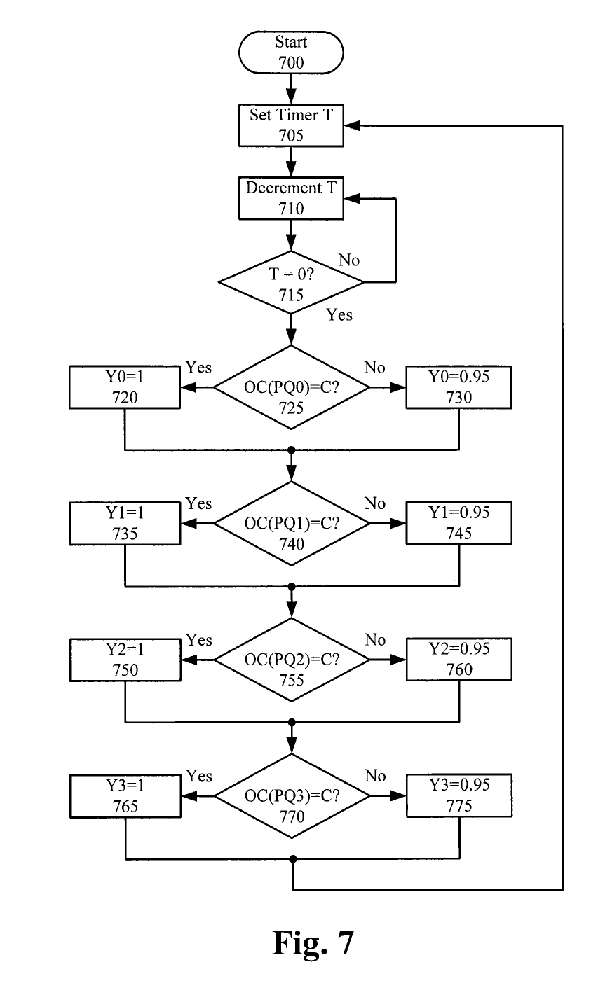

To avoid the above issue, the service rates of the virtual queues may initially be set to 100% of the service rates of the physical queues. Then if the physical queues experience congestion, the service rates of the virtual queues may be lowered to, for example, 95% of the service rate of the physical queues. Thus, the above-described cycle that reduces throughput to zero can be avoided since when there is not congestion the service rates of the virtual queues are set equal to the service rates of the physical queues. This exemplary method of setting the service rates of the virtual queues is described below with reference to FIG. 7. Note that the process for detecting congestion and marking packets is the same as that described above with reference to FIGS. 4-5 whether the service rates of the virtual queues are altered or not. Therefore, FIG. 7 illustrates only the process for changing the service rates of the virtual queues VQ0-VQ3 for the sake of brevity.

The process of FIG. 7 starts at step 700 and sets a timer with an interval T at step 705. The timer is decremented at step 710, and in step 715 it is determined whether the timer value T has reached zero. If the timer value T has not reached zero, the process returns to step 710 to decrement the timer value T again. Thus, the process moves between steps 710 and 715 until the timer value T reaches zero.

When, at step 715, it is determined that the timer value T has reached zero, the process moves to step 725 where it is determined whether the occupancy of physical queue PQ0 has fallen below a predetermined threshold C, which may be zero or some other number. A queue is deemed to be backlogged, or congested, if it does not drain sufficient packets to cause its occupancy to fall below the threshold C within a defined period of time, for example time T in FIG. 7. If at step 725 it is determined that the occupancy of PQ0 has fallen below the threshold C, the process moves to step 720 in order to set the service rate of the corresponding virtual queue, for example VQ0 (not shown) equal to the service rate of the physical queue PQ0. On the other hand, if at step 725 it is determined that the occupancy of PQ0 is above the threshold C, i.e., that PQ0 is congested, the process moves to step 730 where the service rate of the corresponding virtual queue VQ0 is set to 95% of the service rate of PQ0.

After either step 720 or 730, the process moves to step 740 in which it is determined whether the occupancy of physical queue PQ1 has fallen below the threshold C or not. If the occupancy of PQ1 is below the threshold C, the process moves to step 735 to set the service rate of the corresponding virtual queue, for example VQ1 (not show), equal to the service rate of PQ1. Then the process moves to step 755. If at step 740 it is determined that the occupancy of PQ1 is above the threshold C, and therefore that PQ1 is congested, the process moves to step 745 to set the service rate of the corresponding virtual queue VQ1 to 95% of the service rate of PQ1. Then the process moves to step 755.

At step 755, the process checks to see whether the occupancy of physical queue PQ2 is below the threshold C. If it is, the process moves to step 750 to set the service rate of the corresponding virtual queue, for example VQ2 (not shown), equal to the service rate of PQ2. Then the process moves to step 770. If at step 755 it is determined that the occupancy of PQ2 is above the threshold C, the process moves to step 760 to set the service rate of the corresponding virtual queue VQ2 to 95% of the service rate of PQ2. Then the process moves to step 770.

At step 770, the process determines whether the occupancy of physical queue PQ3 is below the threshold C. If it is, the process moves to step 765 to set the service rate of the corresponding virtual queue, for example VQ3 (not shown), equal to the service rate of PQ3. If at step 770 it is determined that the occupancy of PQ3 is above the threshold C, then the process moves to step 775 to set the service rate of the corresponding virtual queue VQ3 to 95% of the service rate of PQ3. After either step 765 or step 775, the process returns to step 705 to reset the timer value and begin again

In the above description, the service rates of the virtual queues are set to be either equal to (Y=1) or to be 95% of (Y=0.95) of the service rate of the corresponding physical queue. However, other values are possible when setting the service rates of the virtual queues to be less than the service rates of the physical queues. For example, any value between 95% and 100% may be used. Further, more than two options for setting the service rates of the virtual queues may be provided. Several fractional values may be stored in a look-up table and the process may choose of those fractional values using predetermined criteria, such as a desired QoS, as an index to the look-up table. Thus, the above descriptions are exemplary and do not in any way limit this disclosure.

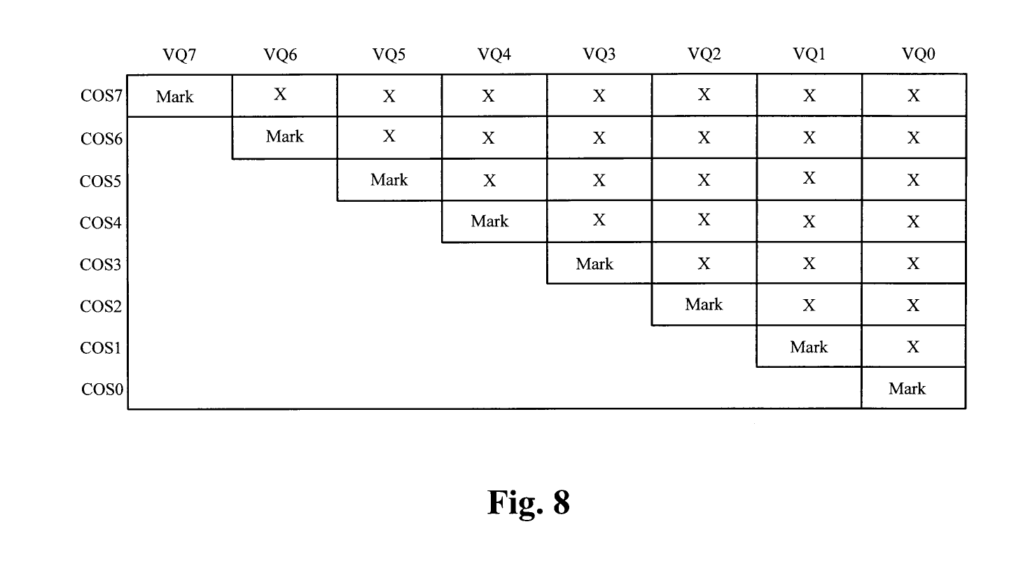

Next, strict priority scheduling in an egress port according to exemplary aspects of the present disclosure is described with reference to FIG. 8. In strict priority scheduling, the highest priority COS takes precedence over all other COS. Since each physical queue is assigned to one COS, a physical queue assigned to the highest priority COS is referred to herein as the highest priority physical queue. In strict priority, the bandwidth of the highest priority physical queue is maintained at the expense of the other physical queues even if it means that transmission is halted for one or more lower priority queues. To achieve the above functionality, the virtual queues monitor subsets of physical queues as described in greater detail below with reference to FIG. 8.

In FIG. 8 the basic structure of the egress port remains unchanged from that of FIG. 4 except that there are eight physical queues COS7-COS0 and eight virtual queues VQ7-VQ0. In FIG. 8 physical queue COS7 corresponds to the highest priority COS, which is set based on the QoS requirements for that COS, and physical queue COS0 corresponds to the lowest priority COS. However, the priority of the physical queues COS7-COS0 may be arranged in any other way without departing from the scope of the present disclosure.

Virtual queues VQ7-VQ0 are also arranged to shadow or monitor one or more of the physical queues COS7-COS0 in order to implement strict priority scheduling For example, in FIG. 8, the virtual queue VQ0 shadows all physical queues COS7-COS0. Virtual queue VQ1 shadows physical queues COS7-COS1, virtual queue VQ2 shadows COS7-COS2, and so on. Virtual Q7 shadows only the highest priority physical queue COS7.

As noted above, each virtual queue VQ7-VQ0 can be a counter. As such, virtual queue VQ0 is incremented any time that any of the physical queues COS7-COS0 output a packet. Virtual queue VQ1 is incremented any time that any one of physical queues COS7-COS1 output a packet, but not when physical queue COS0 outputs a packet. Virtual queue VQ2 is incremented any time that any of the physical queues COS7-COS2 output a packet, but not when physical queues COS1-COS0 output packets, and so on. Virtual queue VQ7 is incremented only when physical queue COS7 outputs a packet since VQ7 has the highest priority. The physical queues that cause a given virtual queue to increment are identified with either an “X” or the word “Mark” in FIG. 8. For example, virtual queue VQ5 is incremented by COS7-COS5, and therefore X's and a “Mark” are illustrated in the COS7-COS5 rows for VQ5 in FIG. 8. The term “Mark” will be explained in more detail below.

Each physical queue COS7-COS0 may have the same service rate, but they more likely have different service rates with the highest priority physical queue COS7 having the highest service rate and the lowest priority physical queue COS0 having the lowest service rate. However, for strict priority scheduling the service rates of the virtual queues VQ7-VQ0 are set to be fractions of the physical, or port, link rate, i.e., the overall drain rate of the egress port. Each virtual queue VQ7-VQ0 may be set to have the same service rate, or may have its own, different service rate as can be appreciated. Of course, congestions thresholds are also provided for the virtual queues, as described above.

In operation, the virtual queue VQ0 is incremented every time that a packet is serviced, i.e., outputted by any one of the physical queues COS7-COS0. If, as a result, VQ0 exceeds the threshold K, then VQ0 will mark a newly arrived packet from COS0, if available. If VQ1 exceeds the threshold K as a result of being incremented by serviced packets from any one of COS7-COS1, VQ1 will mark newly arrived packets from COS1. Each of the other virtual queues VQ2-VQ7 will also be incremented by serviced packets from the physical queues that they monitor, as indicated in FIG. 8. Any virtual queue whose occupancy exceeds the threshold K will mark newly arrived packets from the lowest priority physical queue which they monitor. This is reflected in FIG. 8 with the word “Mark”.

The above-described implementation of strict priority scheduling results in packets from COS0 being marked more frequently than, for example, packets from COS7. This in effect reduces the bandwidth used by the COS of physical queue COS0, and provides the additional bandwidth to the other, higher priority physical queues COS7-COS1. Thus, in strict priority, the bandwidth of higher priority queues is maintained at the expense of the lower priority queues.

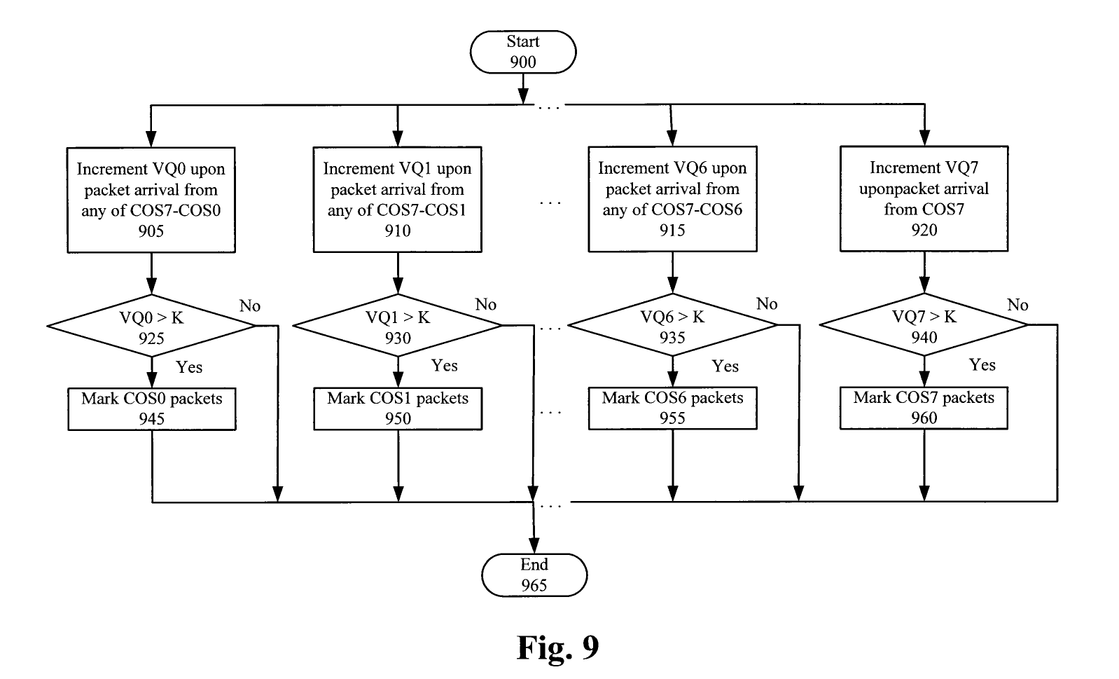

Next, an exemplary method for reducing latency when strict priority scheduling is used is described with reference to FIG. 9. The process of FIG. 9 begins at step 900 and proceeds to one or more of steps 905, 910, 915 or 920 depending on which of the physical queues COS7-COS0 output a packet. As can be appreciated, steps 905, 910, 915 and 920, are typically performed in parallel since each virtual queue monitors one or more physical queues. Therefore, the descriptions below are presented sequentially only for simplicity and ease of understanding.

In FIG. 9, if any of the physical queues COS7-COS0 outputs a packet, virtual queue VQ0 is incremented accordingly at step 905. Then at step 925 it is determine whether the occupancy of VQ0 is greater than the threshold K. If it is, the process moves to step 945 in which a newly arrived packet from the physical queue COS0 is marked. Then the process ends at step 965 with respect to VQ0. If at step 925 it is determined that the occupancy of VQ0 does not exceed the threshold K, then the process with respect to VQ0 ends at step 965.

If any of the physical queues COS7-COS 1 outputs a packet, the process moves to step 910 in order to increment virtual queue VQ1 accordingly. Then at step 930 the occupancy of VQ1 is tested against the threshold K. If the occupancy of VQ1 exceeds the threshold K, the process moves to step 950 in order to mark newly arrived packets from the physical queue COS6. Then the process ends at step 965 with respect to VQ1. If at step 930 it is determined that the occupancy of VQ1 does not exceed the threshold K, the process ends at step 965, with respect to VQ1, without marking newly arrived packets from COS1. This process is carried out for every virtual queue VQ7-VQ0 and their corresponding monitored physical queues, as can be appreciated.

For example, at step 915 any packets arriving from physical queues COS7-COS6 cause the virtual queue VQ6 to be incremented. At step 935 the occupancy of VQ6 is checked against the threshold K, and newly arrived packets from COS6 are marked at step 955 if the occupancy of VQ6 exceeds the threshold K. Then the process ends at step 965 with respect to VQ6. If at step 935 it is determined that the occupancy of VQ6 does not exceed the threshold K, then the process ends at step 965, with respect to VQ6, without marking packets from COS6.

At step 920 virtual queue VQ7 is incremented if a packet arrives from physical queue COS7. Then whether the occupancy of VQ7 exceeds the threshold K is determined at step 940. If it does, newly arrived packets from COS7 are marked at step 960, and the process ends at step 965 with respect to VQ7. On the other hand, if at step 940 it is determined that the occupancy of VQ7 does not exceed the threshold K, the process ends at step 965, with respect to VQ7, without marking packets from COS7.

As noted above, because the process of FIG. 9 is event driven, more than one virtual queue may be checked simultaneously depending upon which physical queue, or physical queues, outputs a packet. For example a packet arriving at the virtual queues from the physical queue COS7 will cause all virtual queues VQ7-VQ0 to be incremented. Therefore, steps 905, 910, 915 and 920 may all be performed simultaneously as a result. After incrementing, each virtual queue VQ7-VQ0 will be checked against the threshold K, which means that steps 925, 930, 935 and 940 may also be performed in parallel, i.e., simultaneously. Likewise, the marking steps 945, 950, 955 and 960 may be performed simultaneously depending on the result of steps 925, 930, 935 and 940. Of course, since the newly received packet is received from COS7, the process may forego steps 925, 930, 935, 945, 950 and 955 since only VQ7 marks packets from COS7. Therefore, if at step 940 it is determined that the occupancy of VQ7 exceeds the threshold K, then the process can proceed directly to step 960 to mark the COS7 packet. In contrast, a packet arriving from physical queue COS0 will only cause virtual queue VQ0 to be incremented and only steps 905, 925, and possibly 945, will be performed as a result.

Further, in the descriptions of FIG. 9, a single threshold K was used for all of the virtual queues VQ7-VQ0 for simplicity. However, each virtual queue VQ7-VQ0 may have its own threshold different from the other virtual queues VQ7-VQ0. The threshold, or thresholds, may also be user settable as will be appreciated by those skilled in the art.

In FIGS. 8-9 eight COS types are serviced using eight physical queues COS7-COS0 and eight virtual queues VQ7-VQ0. However, more COS types may be serviced, requiring more than eight physical/virtual queues, or fewer than eight COS types may be serviced, requiring fewer than eight physical/virtual queues, without departing from the scope of the present disclosure. Also, fewer than eight COS type can be serviced by the structure described in FIGS. 8-9. For example, if there are only four COS types, physical queues COS3-COS0 and virtual queues VQ3-VQ0 can be used, and physical queues COS7-COS4 and virtual queues VQ7-VQ4 are left unused. Therefore, the descriptions of FIGS. 8-9 above are exemplary rather than liming of the present disclosure.

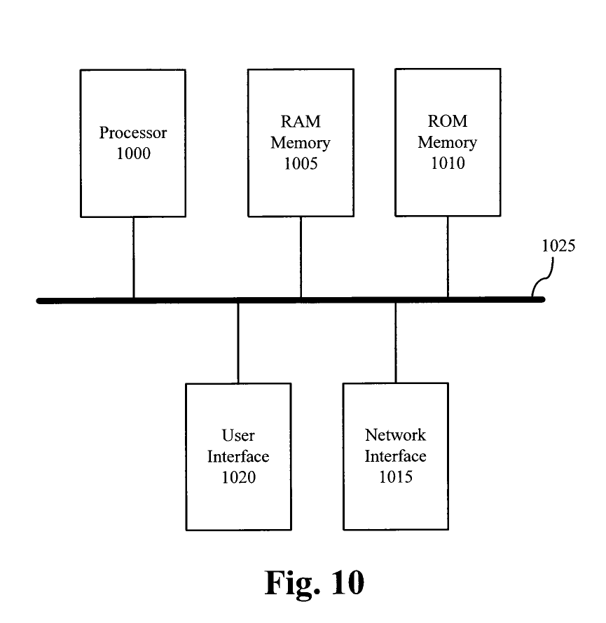

A description of exemplary hardware for reducing latency according to exemplary aspects of this disclosure is provided next with reference to FIG. 10. In FIG. 10 a processor circuit 1000, random access memory (RAM) 1005, read only memory (ROM) 1010, a user interface 1020 and a network interface 1015 are all interconnected via a communications bus 1025. The processor circuit 1000 may provide all or a subset of the functionality for reducing latency that is described above. Computer-readable instructions may also be stored in the RAM 1005 or ROM 1010 in order to cause the processor circuit 1000 to perform this functionality. As such the processor circuit 1000 may read and write information to RAM 1005 and may read information from ROM as one of ordinary skill would recognize.

Processor circuit 1000 may be a general purpose processor circuit having, for example, Harvard architecture, von Neumann architecture, ARM architecture or any combination thereof. The processor circuit 1000 may also include a co-processor to perform a subset of function. The processor circuit 1000 may also be a special-purpose processor, such as a digital signal processor (DSP) or a processor optimized for network communications. In addition or as an alternative, the processor circuit 1000 may be implemented as discrete logic components, in a field programmable gate array (FPGA), in a complex logic device (CPLD), or in an application specific integrated circuit (ASIC). In the event that the processing circuit 1000 is implemented in an FPGA or CPLD, the processor circuit may be organized using a hardware description language such as VHDL. This language describes how the circuit blocks of an FPGA or CPLD are to be connected together in order to provide the required hardware architecture, and the compiled VHDL code may be stored in RAM 1005, ROM 1010 or both. Other processor circuits are also possible as would be recognized by one of ordinary skill in the art.

RAM 1005 may be any random access electronic memory, such as dynamic RAM, static RAM or a combination thereof ROM 1010 may also be any form of read only electronic memory, such as erasable programmable ROM (EPROM), FLASH memory, and the like. All or a portion of RAM 1005 and ROM 1010 may be removable without departing from the scope of the present disclosure.

The network interface 1015 includes any and all circuitry necessary to communicate over a network, as would be recognized by one of ordinary skill in the art. The above-described egress port may be at least partly formed by network interface 1015, for example. Network interface 1015 may also have an ingress port such that packets would not necessarily have to travel via bus 1025 in order to be transmitted through the hardware structure of FIG. 10. Of course, packets may also be routed via the communications bus 1025, as can be appreciated.

The user interface 1020 allow a user to, for example, set the threshold value K, and to access other software controls. As such, the user interface 1020 can include connections for a keyboard, mouse and monitor, or any other user input/output device that is known.

The hardware structure of FIG. 10 is interconnected by bus 1025, which may be a universal serial bus (USB), Firewire™ bus, or any other bus system known to those of skill in the art. The bus may also be a customized bus, and may have a serial or parallel architecture, or both. Alternatively, the circuits and components in FIG. 10 may be interconnected directly without bus 1025. As such, the hardware structure of FIG. 10 is merely exemplary and other hardware structures are possible without departing from the scope of this description.

In the above, latency reduction is described using a network switch egress port for clarity. However, the methods, devices and systems described herein are not limited to network switch egress ports, and may be used in other network components, such as servers, personal computers, and mobile devices. The network may also be wired, fiber optic or wireless, and may be public or private, or a combination of these without departing from the scope of the present disclosure.

Also, the above descriptions include descriptions of algorithmic flowcharts illustrating process steps. These flowcharts are exemplary and the process steps depicted therein may be performed in an order different from the order depicted in the figures. For example, the process steps may be performed in sequential, parallel or reverse order without departing from the scope of the present disclosure. Also, the above descriptions are organized as separate embodiments for ease of understanding of the inventive concepts described. However, one of ordinary skill in the art will recognize that the features of one embodiment may be combined with those of another without departing from the scope of the disclosure. Thus, the particular combination of features described in each of the embodiments is merely exemplary and may be combined without limitation to form additional embodiments without departing from the scope of the disclosure.

Obviously, numerous modifications and variations of the present invention are possible in light of the above teachings. It is therefore to be understood that within the scope of the appended claims, the invention may be practiced otherwise than as specifically described herein.

1. A method of reducing latency in a network device, comprising:
storing packets received from a network in a plurality of physical queues in circuitry of the network device, each packet being stored according to an associated class of service (COS) and a COS associated with each of the physical queues, each physical queue being scheduled based on the COS associated therewith;
shadowing the plurality of physical queues with a plurality of virtual queues implemented in circuitry of the network device;
determining, with the circuitry of the network device, whether congestion exists in at least one of the plurality of virtual queues; and
marking, with the circuitry of the network device, packets departing from at least one of the plurality of physical queues, when congestion is determined to exist in the at least one of the virtual queues,
wherein a service rate of the virtual queues is less than or equal to a port link rate of the network device.

2. The method according to claim 1, wherein each virtual queue shadows a corresponding one of the physical queues, and has a service rate equal to or less than a service rate of the corresponding one of the physical queues.

3. The method according to claim 2, further comprising:
estimating the service rate of the corresponding physical queue based on a number of bytes outputted by the corresponding physical queue over a predetermined time period.

4. The method according to claim 3, further comprising:
lowering a service rate of a virtual queue below a service rate of a corresponding physical queue when congestion exists in the corresponding physical queue; and
increasing the service rate of the virtual queue to be equal to the service rate of the corresponding physical queue when congestion is determined to not exist in the corresponding physical queue.

5. The method according to claim 1, wherein the physical queues are scheduled based on quality of service (QoS) requirements for the COS associated therewith.

6. The method according to claim 1, wherein each virtual queue is implemented by a corresponding counter in the circuitry of the network device.

7. The method according to claim 6, wherein for each virtual queue, the corresponding counter is incremented upon departure of a packet from a corresponding physical queue.

8. The method according to claim 7, wherein each virtual queue shadows a subset of the physical queues, and a counter corresponding thereto is incremented when a packet departs from any of the subset of physical queues monitored.

9. The method according to claim 8, wherein a virtual queue in which congestion is determined to exist marks packets departing from a lowest priority physical queue in the subset of physical queues monitored.

10. The method according to claim 8, wherein a number of physical queues included in the subset of physical queues monitored by each virtual queue is different.

11. The method according to claim 1, wherein the network device is a switch, and the circuitry of the network device is an egress port.

12. A device for reducing latency in a network apparatus, comprising:
circuitry configured to
store packets received from a network in a plurality of physical queues according to a class of service (COS) associated with each packet and each physical queue, the physical queues being scheduled based on a COS associated therewith,
shadow the plurality of physical queues with a plurality of virtual queues,
determine whether congestion exists in at least one of the plurality of virtual queues, and
mark packets departing from at least one of the plurality of physical queues when congestion is determined to exist in the at least one of the plurality of virtual queues,
wherein a service rate of the plurality of virtual queues is less than or equal to a port link rate of the network apparatus.

13. The device according to claim 12, wherein the circuitry is further configured to implement each of the plurality of virtual queues as a counter.

14. The device according to claim 12, wherein each virtual queue shadows a corresponding physical queue and has a service rate less than or equal to the service rate of the corresponding physical queue.

15. The device according to claim 14, wherein the circuitry is further configured to estimate the service rate of the physical queue based on a number of bytes outputted by the physical queue over a predetermined time period.

16. The device according to claim 15, wherein the circuitry is further configured to lower a service rate of a virtual queue below a service rate of a corresponding physical queue when congestion is determined to exist in the corresponding physical queue, and to increase the service rate of the virtual queue to be equal to the service rate of the corresponding physical queue when congestion is determined not to exist in the corresponding physical queue.

17. The device according to claim 12, wherein the physical queues are scheduled based on quality of service (QoS) requirements for the COS associated therewith.

18. The device according to claim 13, wherein for each virtual queue, a counter is incremented upon departure of a packet from a corresponding physical queue.

19. The device according to claim 12, wherein each virtual queue shadows a subset of the physical queues, and a counter corresponding thereto is incremented when a packet departs from any of the subset of physical queues monitored, and
when congestion is determined to exist in a virtual queue, that virtual queue marks packets departing from a lowest priority physical queue in the subset of physical queues monitored by that virtual queue.

20. A non-transitory computer-readable medium encoded with computer-readable instructions thereon that, when executed by a processor, cause the processor to perform a method for reducing latency in a network component, comprising:
storing packets received from a network in a plurality of physical queues, each packet being stored according to an associated class of service (COS) and a COS associated with each of the physical queues, each physical queue being scheduled based on the COS associated therewith;
shadowing the plurality of physical queues with a plurality of virtual queues;
determining whether congestion exists in at least one of the plurality of virtual queues; and
marking packets departing from at least one of the plurality of physical queues, when congestion is determined to exist in the at least one of the virtual queues,
wherein a service rate of the virtual queues is less than or equal to a port link rate of a network device in which the processor is included.
